(19) United States
(12) Patent Application Publication
(10) Pub. No.: US 2002/0090414 A1
(43) Pub. Date: Jul. 11, 2002

(54) Memory material mold

(76) Inventor: Jaaron Johnson, Rapid City, SD (US)

Correspondence Address: Gene R. Woodle, 3516 Woodle Pl., Rapid City, SD, 57702, US

(21) Appl. No.: 10/037,256

(22) Filed: Jan. 2, 2002

Related U.S. Application Data
(60) Provisional application No. 60/260,159, filed on Jan. 8, 2001.

(51) Int. Cl. B29C 33/38; B29C 33/44

(52) U.S. Cl. 425/440; 425/436 RM; 425/470

(57) ABSTRACT

Embodiments of a memory material mold are disclosed in which the mold is made of shape memory material having one shape at one temperture and a second shape at a second temperature. The memory material mold may be used to shape molded articles through change in temperature and shape or to release a molded article after molding by changing shape.

### REFERENCE TO RELATED APPLICATION

This application relies, in part, for priority upon the Provisional Patent Application filed by Jaaron Johnson entitled Memory Material Mold. This Provisional Patent Application was filed Jan. 8, 2001 and assigned application number 60/260,159.

### BACKGROUND OF THE INVENTION

### FIELD OF THE INVENTION

The present invention relates generally to the making of various parts or articles using a poured into or injected into a mold and more specifically to making such articles or parts using a mold made of memory material having shape memory.

### BACKGROUND INFORMATION

In the United States and throughout the world, thousands of parts or articles are produced every day using some type of molding process. In the simplest case, a liquid material such as plastic or hot wax is poured into a mold having the shape of the final product. After the liquid hardens or solidifies, the finished article is removed from the mold. In more complicated cases, the part or article has a protrusion, indentation, or shape which would prevent it from being removed from a single mold after the article material solidifies. In these situations, a two (or more) piece mold is used. After the article material solidifies, the mold pieces are pulled apart to allow release and removal of the part or article. The patent to Kimura (U.S. Pat. No. 5,811,135; Sep. 22, 1998) describes an apparatus to make parts from molten metal using a two part mold.

Materials which have shape memory have been known in the prior art for many years. For purposes of this application such materials are referred to as memory materials. These materials have the capability of being “trained” to have one shape at one temperature and a different shape at a different temperature. The patent to Kimura, for example, uses a “thermally expanding member” to hold the pieces of a two part mold together. The member expands when heated and this expansion holds the two parts of the mold together.

The patent to Douglas (U.S. Pat. No. 4,880,583; Nov. 14, 1989) includes a good discussion of memory materials. Both plastics and metals may be manufactured or manipulated to have shape memory characteristics. Among plastics, polyethylene terephthalate, polyaryl sulphones, and polycarbonates may be memory materials. Among metals, various alloys of titanium and nickel may be memory materials.

The invention presented in the present application is believed to solve, in a simple and effective fashion, a problem which has long plagued people who mold items having shapes difficult to pour using conventional molding techniques: Simple shapes such a cubes are easy to mold because the article material may be poured into a single mold and easily removed. However, many molded articles have a shape which include indentations, protrusions, or shapes which prevent them from being removed from the mold after they harden. The current solution to these problems is to create a mold which has two or more separate mold pieces or to manufacture the article using a different process. In other cases, it is possible to create shapes with a mold which changes shape which could not be conveniently created with a conventional mold.

The ideal memory material mold should provide a method of conveniently creating a single piece mold which has one shape at one temperature and a second shape at a second temperature.

The ideal memory material mold should have a second shape which it assumes at a different temperature than the initial shape which allows for the creation of shapes not easily achievable using conventional molding techniques or which allows for release and removal of the molded articles which is not possible using conventional molding techniques.

The ideal memory material mold should also be simple, rugged, inexpensive, and easy to use.

### SUMMARY OF THE INVENTION

The memory material mold of the instant invention includes a single piece mold made of memory material which has been “trained” to have one shape at one temperature and a second shape at a second temperature. At the initial shape and temperature the article material is introduced into or onto the mold. The memory material mold is then heated or cooled to the final temperature and shape. In the first embodiment of the memory material mold of the instant invention, the initial state serves as an easy and convenient method to introduce the article material and the final state transforms the article material into a shape difficult to achieve using conventional molding techniques. In a second embodiment of the memory material mold of the instant invention, the article material achieves its final shape in the initial state and the change in memory material mold shape allows the finished article to be removed from the mold.

The first embodiment of the memory material mold of the instant invention may be explained as a device to make an original shape of cookie, for example. A memory material mold having the initial state of a flattened, representative, giraffe may be created. The memory material mold is “trained” to have the shape of a standing, three dimensional, giraffe at its final state. A cookie cutter is also provided which may be used to cut a shape out of cookie dough which is the same as the size and shape of the memory metal mold in its initial state. The dough is placed upon the memory material mold in the initial shape and the dough and the mold are placed in the oven. The mold and the dough are heated to a temperature which will cause the mold to change to the final shape and which will cook the dough.

Another application of this embodiment allows the molding of items, such as a sphere, which may not be made using a single, conventional mold. This application requires that the article material be plastic or malleable at the initial state and temperature, harden or solidify at the final state and temperature, and remain solidified when returned to the initial temperature. The memory material mold at the initial state has the shape of a series of rounded points, something like a picket fence, with another series of rounded points which mirror the first series. This shape is also similar to early world maps as it is the shape of a paper sphere which has been cut and flattened out. A volume of article material having the same volume as the desired sphere (if the material shrinks or expands with temperature change, volume adjustment may be necessary) is rolled and spread evenly over the initial state memory material mold in the exact size and shape as the memory material mold. The memory material mold is then heated or cooled to the final state temperature and the memory article material and the article material assume the final state shape which is a sphere. After the article material solidifies or hardens, the memory material mold and article material are returned to the initial state temperature. The memory material mold resumes the flat shape and releases the finished article for easy removal.

In the second embodiment of the memory material mold of the instant invention, the article material achieves its final shape in the initial state and the change in memory material mold shape allows the finished article to be removed from the mold. A shape such as a cube or a rectangular solid are easy to mold using a single piece conventional mold. However, adding an indented channel, for example, to the cube or rectangular solid make the article impossible to remove from a conventional single piece mold. In this embodiment the memory material mold has the shape of the desired finished article at the initial state. The article material is introduced into the mold and allowed to harden or solidify. The memory material mold has been “trained” to assume a second shape at the final state in which the new shape is such that the mold has released or pulled away from the article and the article may be removed.

One of the major objects of the present invention is to provide a memory material mold which provides a method of conveniently creating a single piece mold which has one shape at one temperature and a second shape at a second temperature.

Another objective of the present invention is to provide a memory material mold which has an initial shape at one temperature and a second shape which it assumes at a different temperature than the initial shape which allows for the creation of shapes not easily achievable using conventional molding techniques or which allows for release and removal of the molded articles which is not possible using conventional molding techniques.

Another objective of the present invention is to provide a memory material mold which is simple, rugged, inexpensive, and easy to use.

These and other features of the invention will become apparent when taken in consideration with the following detailed description and the drawings.

### BRIEF DESCRIPTION OF THE DRAWINGS

FIG. 1 is a top view of a typical memory material mold of the instant invention in an initial shape;

FIG. 2 is a side view of the memory material mold of FIG. 1 in a second or final shape;

FIG. 3 is a top view of an article material cutter which could be used with the memory material mold of FIG. 1;

FIG. 4 is a side view of an article material cutter which is shown in FIG. 3;

FIG. 5 is a top view of the memory material mold of the instant invention showing its use to create alternate shapes to that shown in FIG. 1;

FIG. 6 is a side view of the memory material mold of FIG. 5 showing the invention in a transitional position;

FIG. 7 is a sectional view of the memory material mold of FIG. 6 taken along line 7-7;

FIG. 8 is a side view of the memory material mold of FIG. 5 in a second or final position;

FIG. 9 is a perspective view of a typical article which may be molded using a second embodiment of the memory material mold of the instant invention;

FIG. 10 is a perspective view of a memory material mold which may be used to produce the typical article depicted in FIG. 9;

FIG. 11 is a sectional view of the memory material mold of FIG. 10 taken along line 11-11; and

FIG. 12 is a sectional view of the memory material mold of FIG. 10 taken along line 11-11 at the final or second state of the memory material mold.

### DESCRIPTION OF A PREFERRED EMBODIMENT

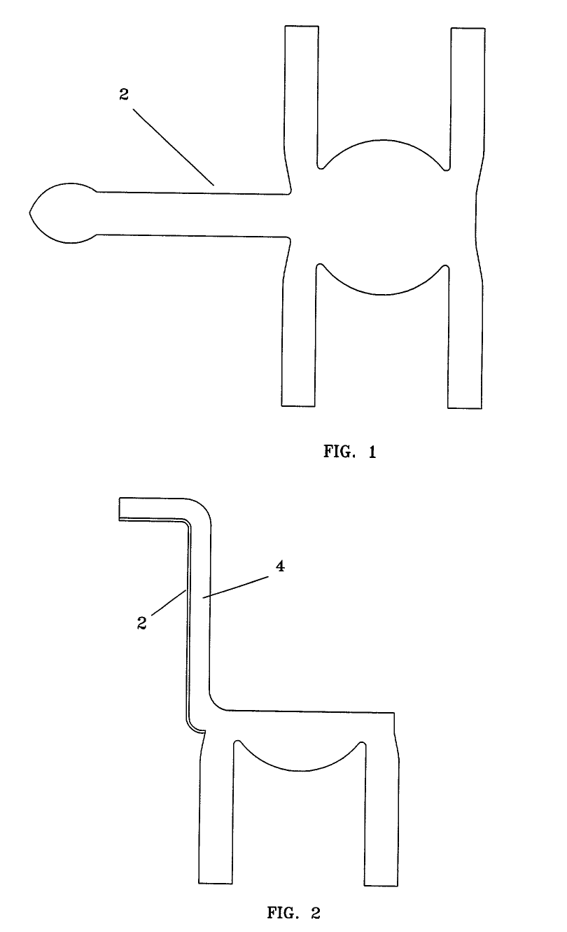

Referring to the drawings, FIGS. 1 through 13, there is shown a preferred form of the memory material mold embodying the present invention with two basic embodiments. The memory material mold of the instant invention includes a single piece mold made of memory material which has been “trained” to have one shape at one temperature and a second shape at a second temperature. At the initial shape and temperature the article material is introduced into or onto the mold. The memory material mold is then heated or cooled to the final temperature and shape. In the first embodiment of the memory material mold of the instant invention, the initial state serves as an easy and convenient method to introduce the article material and the final state transforms the article material into a shape difficult to achieve using conventional molding techniques. In a second embodiment of the memory material mold of the instant invention, the article material achieves its final shape in the initial state and the change in memory material mold shape allows the finished article to be removed from the mold.

Referring to FIG. 1, a top view of a typical memory material mold of the instant invention in an initial shape is shown. As an example, a method of making a giraffe shaped cookie is depicted in this Figure and in FIGS. 2, 3, and 4. Memory material is one of a number of plastic or metal materials which may be “trained” to have one shape at one temperature and another shape at a second temperature. The first shape is referred to as the initial shape and the second shape is referred to as the final shape. FIG. 1 shows a giraffe mold 2 in its initial shape which is a flattened, representational depiction of a giraffe.

Referring now to FIG. 2, a side view of the memory material mold of FIG. 1 in its final shape. In this Figure the memory metal mold 2 has assumed the second or final shape which it has been “trained” to assume at a second temperature different from the temperature at which the memory metal mold 2 assumed in its initial stage. Cookie dough 4 has been pressed onto said memory metal mold 2 in its initial state and has assumed the upright, three dimensional shape represented by said memory metal mold 2 in its final state or shape.

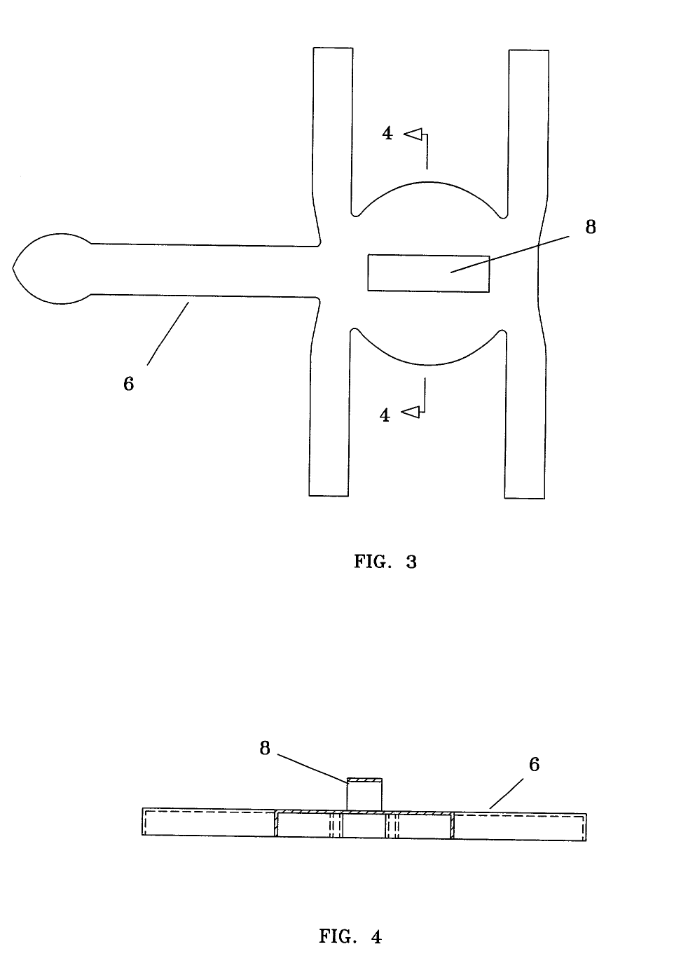

Referring now to FIG. 3, a top view of an article material cutter which could be used with said memory material mold 2 of FIG. 1 is shown. This figure shows one possible method of shaping and cutting the article material (in this case cookie dough) for use with said memory material mold 2. A cookie cutter 6 is supplied which has the same shape as said memory material mold 2 in its initial state and is larger by the wall thickness of said cookie cutter 6. The cookie cutter 6 includes a handle 8 which protrudes upward from said cookie cutter 6 and provides a convenient method for manipulating said cookie cutter 6.

Referring now to FIG. 4 a side view of said cookie cutter 6 is shown. Said cookie cutter 6 has a solid top to which said handle 8 is affixed. Said cookie cutter 6 has sides which define the thickness of the article material (cookie dough) and is open on the bottom.

In operation, the article material (cookie dough) is rolled out to the approximate desired thickness of the material which is approximately the same as the length of the sides of said cookie cutter 6. Said cookie cutter 6 is pressed down through the article material and cuts out a segment of article material the same size and shape as said memory material mold 2. The cut out article material is transferred to and aligned with said memory material mold 2 and both are put in an oven. Said memory material mold 2 has been “trained” to assume the shape of its final state as shown in FIG. 2 at an appropriate temperature for cooking the article material. As said memory material mold 2 changes from its initial state to its final state, it also forces the article material to form the same general shape. After the article material is cooked, said memory material mold 2 may be removed leaving a giraffe shaped cookie.

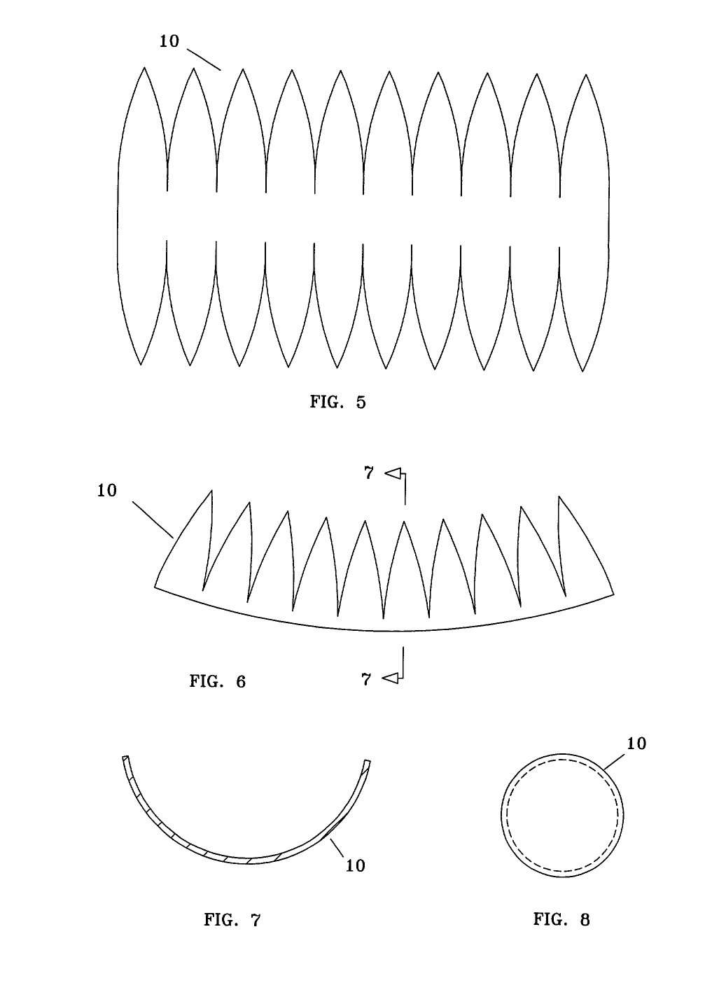

Referring now to FIG. 5 a top view of the memory material mold of the instant invention showing its use to create alternate shapes to that shown in FIG. 1 is shown. This figure and FIGS. 6, 7, and 8 show the use of the memory material mold of the instant invention to create an article which is surrounded by the memory material mold rather than being placed upon the mold as is depicted in FIGS. 1 through 4. A sphere mold 10 is shown in FIG. 5. This shape is one of the methods of creating a flat surface which may be transformed into the surface of a sphere by bending and shaping without making cuts or having extra material. This method works with article material which is plastic or malleable at the temperature of the initial state of sphere mold 10. A volume of article material (not shown) which is equal to the volume of the desired spherical shape is spread to an equal thickness over said sphere mold 10 such that it is the same size and shape as said sphere mold 10. If the article material shrinks or expands at final state temperature, volume adjustments may have to be made. After the article material is placed upon said sphere mold 10, the article material and said sphere mold 10 are heated or cooled to the final state temperature of said sphere mold 10.

Now referring to FIG. 6, a side view of said sphere mold 10 is shown in a transitional position. Said sphere mold 10 has been “trained” to assume the flat shape shown in FIG. 5 at its initial state and temperature. Said sphere mold 10 has also been “trained” to assume the shape of a sphere at its final state and temperature. This figure shows said sphere mold 10 as it begins to bend longitudinally and laterally in its transformation from the flat initial state to the spherical final state.

Now referring to FIG. 7, a sectional view of said sphere mold 10 in the transitional phase is shown. This view shows the lateral bending of said sphere mold 10.

Now referring to FIG. 8, a side view of said sphere mold 10 in its final state is shown. At this point said sphere mold 10 and the article material have reached the final state temperature and said sphere mold 10 has assumed the shape of a sphere. Said sphere mold 10 has completely surrounded the article material and forced the article material to assume the shape of the sphere. The final state temperature is maintained until the article material has solidified or hardened and will not return to its original shape. Said sphere mold 10 and the article material may then be returned to the temperature of the initial state. Said sphere mold 10 returns to its initial, flat shape and pulls away from and releases the final article.

FIGS. 9 through 12 show a second embodiment of the memory material mold of the instant invention. In this embodiment, a single mold may be used to produce an article which has indentations, protrusions, or a shape which prevents it from being removed from a single piece mold using conventional processes.

Referring now to FIG. 9, a perspective view of a typical article which may be molded using the memory material mold of the instant invention is shown. A solid article 14 which is to be produced is shown. This shape, a rectangular solid with two channels 16 indented into the solid, is representative of the types of shapes which may be produced. It may be easily seen that a variety of other shapes could be produced using the memory material mold of the instant invention. It may also be easily seen that the two channels 16 would prevent the article from being removed from a conventional single piece mold.

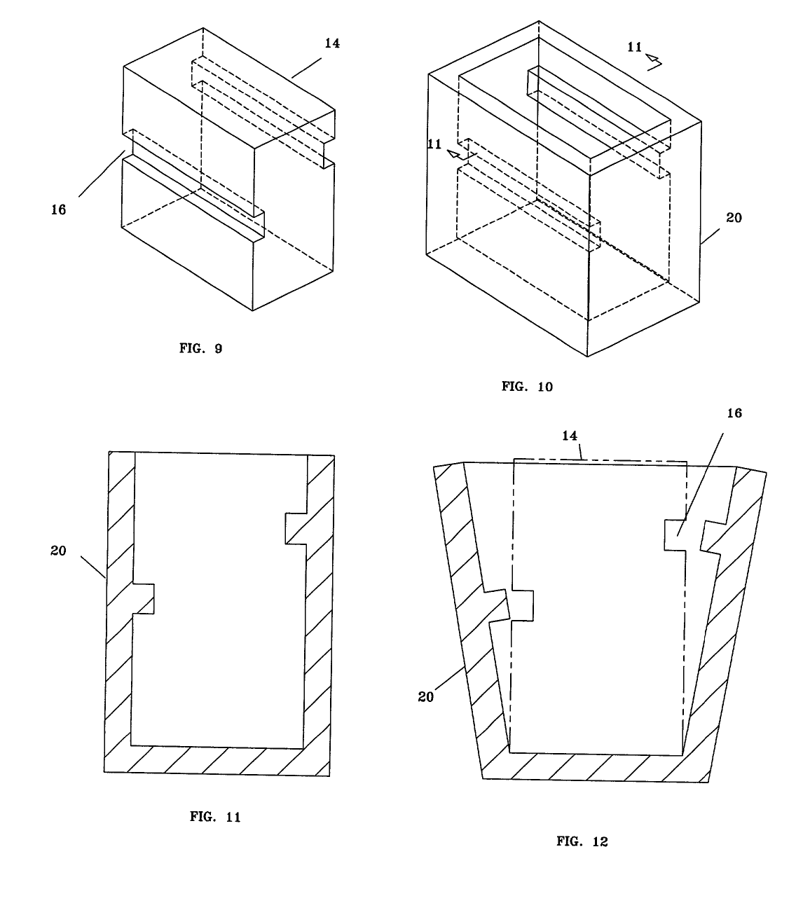

Referring now to FIG. 10, a perspective view of a rectangle mold 20 which may be used to produce the solid article 14 depicted in FIG. 9 is shown. This is the initial state of the rectangle mold 20 and the memory material has been “trained” to assume the shape in its hollow interior of the solid article 14. Said rectangle mold 20 is of a shape and size that it may completely enclose said solid article 14. The interior of said rectangle mold 20 is hollow and the interior surface of said rectangle mold 20 has the same size and shape as the exterior surface of said solid article 14. The article material may shrink or expand and size adjustments may have to be made to achieve a finished article of the desired size.

Now referring to FIG. 11, a sectional view of said rectangular mold 20 taken along line 11-11 of FIG. 10 is shown. This view shows the interior shape of said rectangular mold 20 at its initial state.

Now referring to FIG. 12, a sectional view of said rectangular mold 20 taken along line 11-11 of FIG. 10 at its final state is shown. A section of solid article 14 is also shown in phantom lines. As can be seen from this view, said rectangular mold 20 has been “trained” to expand in the final state such that the protrusions on said rectangular mold 20 which formed said channels 16 in said solid article 14 have pulled away from said solid article 14.

In operation, with said rectangular mold 20 at its initial state temperature, the article material is introduced into the mold. In most cases, the article material is such that it will harden or solidify at this temperature. After the article material has hardened or solidified, said solid article 14 and said rectangular mold 20 are heated or cooled to the temperature at which said rectangular mold 20 reaches its final state. At this point, said rectangular mold 20 has changed shape such that said solid article 14 may easily be removed from said rectangular mold 20.

In the preferred embodiment of the memory material mold of the instant invention the memory material mold is made from a nickel/titanium alloy but other materials having the same strength, weight, resistance to oxidation, etc. could be used, provided the material had the appropriate shape memory characteristics. In the preferred embodiments of the memory metal mold of the instant invention, the composition of the nickel/titanium alloy was 50/50, but other ratios of components may be used to vary the temperatures at which the shape memory material changes shape. A variety of shape memory materials including both metal and plastics are conventional and capable of being purchased from a number of sources.

While preferred embodiments of this invention have been shown and described above, it will be apparent to those skilled in the art that various modifications may be made in these embodiments without departing from the spirit of the present invention.

I claim:

1. A mold comprising;
a mold body made of shape memory material, the shape memory material having the characteristics of assuming a first shape at temperature one and assuming a second shape at temperature two; the mold body being capable of being loaded with the material to be molded at temperature one; and, upon said mold body and the material to be molded being brought to temperature two, said mold body assumes its second shape and forces the material to be molded to also assume the second shape.

2. A mold comprising;
a mold body made of shape memory material, the shape memory material having the characteristics of assuming a first shape at temperature one and assuming a second shape at temperature two; the mold body being capable of being loaded with the material to be molded at temperature one; and, upon said mold body and the material to be molded being brought to temperature two, said mold body assumes its second shape and forces the material to be molded to also assume the second shape; and, upon said mold body and the material to be molded being brought back to temperature one, said mold body resumes its first shape and releases the material to be molded and the material to be molded retains the second shape.

3. A mold comprising;
a mold body made of shape memory material, the shape memory material having the characteristics of assuming a first shape at temperature one and assuming a second shape at temperature two; the mold body being capable of being loaded with the material to be molded at temperature one; the material to be molded at temperature one being allowed to set or harden; and said mold body and the material to be molded being brought to temperature two and said mold body assuming its second shape and releasing the material to be molded.

4. The mold of claim 1, wherein the first shape of said mold body is flat; the material to be molded is cookie dough; and the cookie dough is placed upon the top surface of said mold body; temperature two is the cooking temperature of the cookie dough; and, as said mold body and the cookie dough are brought from temperature one to temperature two, said mold body and said cookie dough assume the shape of a three dimensional cookie.

5. The mold of claim 2, wherein the first shape of said mold body is flat; the material to be molded is cookie dough, and the cookie dough is placed upon the top surface of said mold body, temperature two is the cooking temperature of the cookie dough; said mold body and the cookie dough are brought from temperature one to temperature two and assume shape two; the cookie dough cooks and fixes the shape of the cookie dough; said mold body and the cookie dough are returned to temperature one; and said mold body assumes shape one and releases the cookie dough which retains shape two.
